(19) United States
(12) Patent Application Publication
(10) Pub. No.: US 2026/0011803 A1
(43) Pub. Date: Jan. 8, 2026

(54) DISASSEMBLY METHOD FOR ELECTRICITY STORAGE DEVICE

(71) Applicant: Prime Planet Energy & Solutions, Inc., Tokyo (JP)

(72) Inventor: Yozo UCHIDA, Toyota-shi (JP)

(21) Appl. No.: 19/251,798

(22) Filed: Jun. 27, 2025

(30) Foreign Application Priority Data
Jul. 5, 2024 (JP) 2024-108911

(51) Int. Cl. H01M 10/54

(52) U.S. Cl. CPC H01M 10/54

(57) ABSTRACT

A disassembly method for a battery disclosed herein includes a removal step of removing an electrode assembly from the battery. The method also includes an immersion step of immersing at least a part of the removed electrode assembly in a liquid. The method further includes a separation step of separating the positive electrode current collector foil and the negative electrode current collector foil from each other by pulling at least one of the positive electrode current collector foil and the negative electrode current collector foil, which are immersed in the liquid, so as to displace the positive electrode current collector foil and the negative electrode current collector foil in a direction intersecting the laminating direction thereof.

### CROSS REFERENCE TO RELATED APPLICATION

This application claims the benefit of priority to Japanese Patent Application No. 2024-108911 filed on Jul. 5, 2024. The entire contents of this application are hereby incorporated herein by reference.

### BACKGROUND OF THE DISCLOSURE

### 1. Field

The present disclosure relates to a disassembly method for an electricity storage device.

### 2. Background

Japanese Patent Application Publication No. 2021-73375 discloses a recycling method for a lithium-ion battery. According to this recycling method, the lithium-ion battery is shredded into small pieces to recover the electrode materials.

### SUMMARY

Meanwhile, there is a growing need for further development of methods that can efficiently recover resources contained in a positive electrode and a negative electrode from an electrode assembly, in which a positive electrode current collector foil and a negative electrode current collector foil are laminated with a separator interposed therebetween (hereinafter also referred to as a “laminated electrode assembly”).

The disassembly method for an electricity storage device disclosed herein includes a step of removing an electrode assembly from the electricity storage device, the electricity storage device including the electrode assembly in which a positive electrode current collector foil and a negative electrode current collector foil are laminated with a separator interposed therebetween. The method also includes a step of immersing at least a part of the removed electrode assembly in a liquid. The method further includes a step of separating the positive electrode current collector foil and the negative electrode current collector foil by pulling at least one of the positive electrode current collector foil and the negative electrode current collector foil immersed in the liquid such that the positive electrode current collector foil and the negative electrode current collector foil are displaced in a direction intersecting the laminating direction thereof. According to such a disassembly method for an electricity storage device, the resources included in the positive electrode and the negative electrode can be efficiently recovered from the laminated electrode assembly.

### BRIEF DESCRIPTION OF THE DRAWINGS

FIG. 1 is a perspective view schematically illustrating a secondary battery according to one embodiment.

FIG. 2 is a perspective view of the secondary battery of FIG. 1, with its top and bottom sides reversed.

FIG. 3 is a explanatory diagram schematically illustrating an internal structure of the secondary battery of FIG. 1.

FIG. 4 is a perspective view schematically illustrating an electrode assembly attached to closing plates.

FIG. 5 is a perspective view schematically illustrating the configuration of the electrode assembly included in the battery of FIG. 1.

FIG. 6 is a schematic diagram illustrating a battery disassembly device according to another embodiment.

FIG. 7 is a schematic explanatory diagram for explaining a separation step in the disassembly method for a battery according to another embodiment.

FIG. 8 is a schematic explanatory diagram for explaining the separation between a positive electrode current collector foil and a negative electrode current collector foil.

FIG. 9 is a flowchart for explaining a disassembly method for a battery according to another embodiment.

### DETAILED DESCRIPTION OF THE EMBODIMENTS

Hereinafter, some embodiments of the technology disclosed herein will be described with reference to the drawings. In the following drawings, members and portions that have the same actions are denoted by the same symbols. The dimensional relationships (length, width, thickness, etc.) in each drawing do not reflect the actual dimensional relationships. Matters that are necessary for carrying out the technology disclosed herein but are not specifically mentioned herein (e.g., general structure and manufacturing process of electricity storage devices that do not characterize the present disclosure) may be understood by those skilled in the art as design matters based on techniques known in the related art. The techniques disclosed herein may be carried out on the basis of the contents disclosed herein and common technical knowledge in the field. The following description is not intended to limit the present disclosure to the embodiments below.

The notation “A to B” indicative of a range herein means “A or more and B or less”. It shall also encompass the meanings of “greater than A” and “less than B”. As used herein, the phrase “direction that is substantially orthogonal to a certain predetermined direction (e.g., laminating direction or displacement direction)” does not need to mean that an angle at which the predetermined direction and the substantially orthogonal direction intersect each other is strictly 90° (right angle). That is, “substantially orthogonal” can encompass the substantial angle that can exert the effects of the present disclosure. For example, the intersecting angle only needs to be from 80° to 100°, and is more preferably from 85° to 95°, and particularly preferably 90°. As used herein, “electricity storage device” refers to a device that can be charged and discharged. Electricity storage devices encompass primary batteries, secondary batteries (e.g., non-aqueous electrolyte secondary batteries such as lithium-ion secondary batteries, and nickel hydride batteries), and capacitors (physical batteries) such as electric double layer capacitors. The electrolyte may be any one of a liquid electrolyte (electrolyte solution), a gel electrolyte, or a solid electrolyte. A lithium-ion secondary battery (hereinafter simply referred to as a “battery 100”), which is one embodiment of the electricity storage device disclosed herein, is described below by way of example.

### <Configuration of Battery>

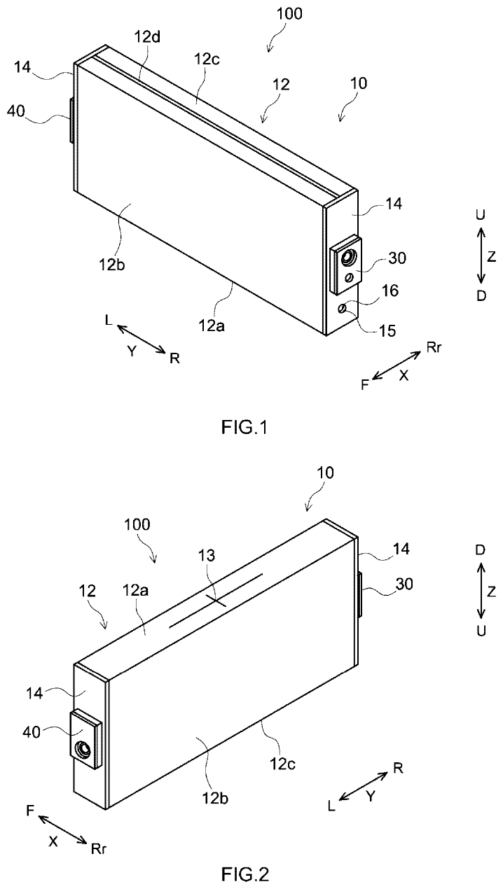

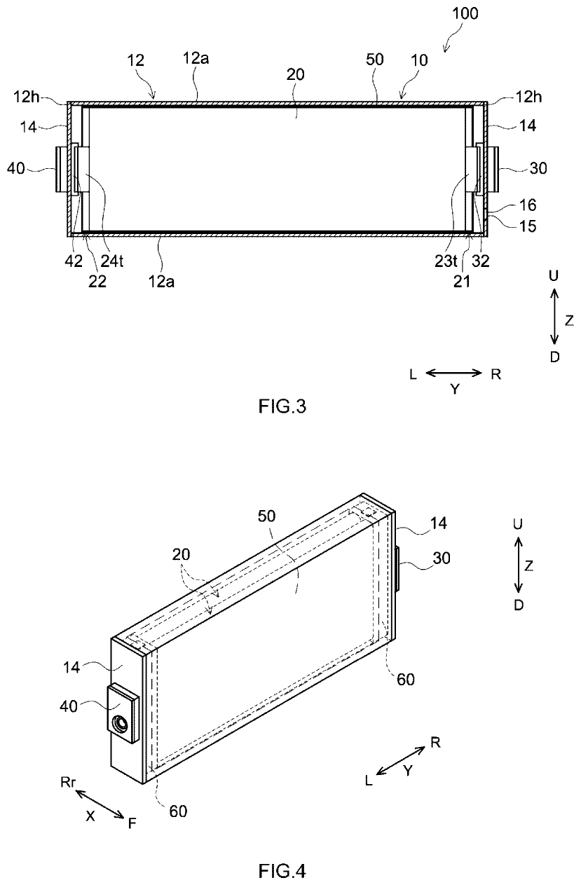

FIG. 1 is a perspective view of the battery 100 according to one embodiment. FIG. 2 is a perspective view of the battery 100 of FIG. 1, with its top and bottom sides reversed. FIG. 3 illustrates an internal structure of the battery 100 of FIG. 1. In the following description, the signs L, R, F, Rr, U, and D in the drawings represent left, right, front, rear, top, and bottom, respectively, and the signs X, Y, and Z in the drawings represent the short side direction of the battery 100, the long side direction thereof orthogonal to the short side direction, and the vertical direction thereof orthogonal to the short side direction and long side direction, respectively. However, these directions are provided for convenience of explanation and do not limit the installation forms of the battery 100 at all.

As illustrated in FIG. 3, the battery 100 includes a battery case 10, an electrode assembly 20, a positive electrode terminal 30, a negative electrode terminal 40, and an insulating film 50. Although not illustrated in the drawings, the battery 100 here further includes an electrolyte solution. The battery 100 here is a lithium-ion secondary battery. The battery 100 is preferably a lithium-ion secondary battery.

The battery case 10 is a housing that houses the electrode assembly 20, the insulating film 50, and the electrolyte solution therein. As illustrated in FIGS. 1 and 2, the battery case 10 here has a flat rectangular parallelepiped (rectangular) outer shape with a bottom. The battery case 10 is preferably rectangular. The material of the battery case 10 may be the same as that conventionally used and is not particularly limited. The battery case 10 is preferably made of metal, for example, more preferably aluminum, an aluminum alloy, iron, an iron alloy, or the like.

As illustrated in FIG. 3, the battery case 10 here includes a case body 12 with a pair of openings 12h and two closing plates 14 that close the pair of openings 12h. The case body 12 and the closing plates 14 in the battery case 10 are integrated together by joining (e.g., welding) the closing plates 14 to the peripheral edges of the pair of openings 12h of the case body 12. The battery case 10 is hermetically sealed (made airtight).

As illustrated in FIG. 1, the case body 12 has a rectangular tube shape and has a bottom surface 12a with a substantially rectangular shape, a pair of long side surfaces 12b extending from long sides of the bottom surface 12a and opposed to each other, and a top surface 12c connecting upper end portions of the pair of long side surfaces 12b. The top surface 12c has a substantially rectangular shape. The top surface 12c is opposed to the bottom surface 12a. The case body 12 is formed by, for example, bending a single metal plate into a tube shape and joining seams (e.g., by welding). Here, a weld joint 12d is located on the top surface 12c. On the bottom surface 12a, a gas discharge valve 13 is provided.

The gas discharge valve 13 is configured to break when the pressure in the battery case 10 reaches a predetermined value or higher, thereby discharging the gas in the battery case 10 to the outside. In the present embodiment, there is one gas discharge valve 13, but two or more gas discharge valves 13 may be provided. In the present embodiment, the gas discharge valve 13 is provided on the bottom surface 12a, but in other embodiments, the gas discharge valve 13 may be provided on a surface other than the bottom surface 12a, such as the long side surface 12b, the top surface 12c, or the closing plate 14. The area of the gas discharge valve 13 is arbitrary.

In the present embodiment, the gas discharge valve 13 is a cross-shaped notch. However, the shape of the gas discharge valve 13 is not particularly limited. In other embodiments, the gas discharge valve 13 may be, for example, a linear notch (in the form of a vertical or horizontal line only), a conventionally known oval-shaped valve (with a notch in its interior), a circular valve (with a notch in its interior), or the like. The dimensions (length and depth) of the notch are arbitrary and can be determined as appropriate in consideration of, for example, the pressure resistance of the battery case 10.

The closing plate 14 is a plate-shaped member that closes the opening 12h. The closing plate 14 has a substantially rectangular shape in planar view. The area of each closing plate 14 is smaller than that of the long side surface 12b. The closing plate 14 is provided with a pouring hole 15. The pouring hole 15 is used to pour the electrolyte solution into the battery case 10 after the closing plates 14 are assembled to the case body 12. The pouring hole 15 is sealed by a sealing member 16 after the electrolyte solution is poured. In the present embodiment, the pouring hole 15 is provided in the closing plate 14, but in other embodiments, the pouring hole 15 may be provided in the case body 12. In the present embodiment, the pouring hole 15 is provided on a different surface from the gas discharge valve 13, but in other embodiments, the pouring hole 15 may be provided on the same surface as the gas discharge valve 13.

The positive electrode terminal 30 and the negative electrode terminal 40 are each fixed to the battery case 10. Here, the positive electrode terminal 30 and the negative electrode terminal 40 are fixed to respective opposed surfaces of the battery case 10 (specifically, the respective closing plates 14). In detail, the positive electrode terminal 30 is attached to the closing plate 14 disposed on one side in the long side direction Y (on the right side in FIGS. 1 and 2). The negative electrode terminal 40 is attached to the closing plate 14 disposed on the other side in the long side direction Y (on the left side in FIGS. 1 and 2). Although the positive electrode terminal 30 and the negative electrode terminal 40 are provided in the respective closing plates 14 in the present embodiment, the positive electrode terminal 30 and the negative electrode terminal 40 may be provided in the case body 12 in other embodiments. Alternatively, in other embodiments, the positive electrode terminal 30 and the negative electrode terminal 40 may both be provided on one of the closing plates 14. In the present embodiment, the positive electrode terminal 30 and the negative electrode terminal 40 are provided on the surfaces different from the gas discharge valve 13, but in other embodiments, the positive electrode terminal 30 and the negative electrode terminal 40 may be provided on the same surface as the gas discharge valve 13.

The positive electrode terminal 30 and the negative electrode terminal 40 are exposed at respective outer surfaces of the closing plates 14. Each of the positive electrode terminal 30 and the negative electrode terminal 40 is here disposed on an axis that extends in the long side direction Y and passes through the center of the corresponding closing plate 14. However, in other embodiments, the axis may be displaced from the center of the closing plate 14, for example, in the short side direction X. The positive electrode terminal 30 and the negative electrode terminal 40 may not be disposed on the axis. For example, one of the positive electrode terminal 30 and the negative electrode terminal 40 may be displaced toward one side in the short side direction X, and the other electrode terminal to the other side in the short side direction X.

The positive electrode terminal 30 is preferably made of metal, for example, more preferably aluminum or an aluminum alloy. The negative electrode terminal 40 is preferably made of metal, for example, more preferably copper or a copper alloy.

As illustrated in FIG. 3, the positive electrode terminal 30 is electrically connected to a positive electrode 21 of the electrode assembly 20 via a positive electrode current collector portion 32 inside the battery case 10. The negative electrode terminal 40 is electrically connected to a negative electrode 22 of the electrode assembly 20 via a negative electrode current collector portion 42 inside the battery case 10. The positive electrode terminal 30 and the negative electrode terminal 40 are each insulated from the case body 12 by the insulating film 50. The positive electrode terminal 30 and the negative electrode terminal 40 are insulated from the closing plates 14 by an insulating member 60 (see FIG. 4).

The electrode assembly 20 is housed inside the battery case 10. FIG. 4 is a perspective view of the electrode assembly 20 attached to the closing plates 14. As illustrated in FIG. 4, the electrode assembly 20 is disposed inside the battery case 10, while being covered with the insulating film 50 described below. In the present embodiment, a plurality of (two in FIG. 4) electrode assemblies 20 are housed inside one battery case 10. However, the number of electrode assemblies 20 housed inside one battery case 10 is not particularly limited and may be three or more or one in other embodiments.

FIG. 5 is a perspective view schematically illustrating the configuration of the electrode assembly included in the battery of FIG. 1. For ease of viewing, FIG. 5 illustrates parts of the positive electrode 21, the negative electrode 22, and a separator 26 which are included in the electrode assembly 20. As illustrated in FIG. 5, the electrode assembly 20 includes the positive electrode 21 and the negative electrode 22. The electrode assembly 20 is a laminated electrode assembly, in which positive electrodes 21 and negative electrodes 22 are laminated with the separator 26 interposed between adjacent electrodes; each positive electrode 21 has a positive electrode active material layer 23b disposed on a positive electrode current collector foil 23a, and each negative electrode 22 has a negative electrode active material layer 24b disposed on a negative electrode current collector foil 24a. Specifically, the electrode assembly 20 is formed by laminating the square-shaped positive electrodes 21 and the square-shaped negative electrodes 22 on top of each other in an insulated state. In another embodiment, the electrode assembly 20 may be a folded laminated electrode assembly in which a plurality of positive electrodes 21 and a plurality of negative electrodes 22 are each sandwiched between portions of the separator 26 folded in a zigzag manner.

The electrode assembly 20 has a positive electrode tab 23t and a negative electrode tab 24t, extending in opposite directions from each other, as illustrated in FIG. 5. The positive electrode tab 23t is a portion of the electrode assembly 20 that extends from its first (right) end portion toward a first side. The positive electrode tab 23t is a portion where the positive electrode active material layer 23b is not formed and the positive electrode current collector foil 23a is exposed. The positive electrode tab 23t is formed by laminating a plurality of layers of the positive electrode current collector foils 23a protruding toward the first side. The negative electrode tab 24t is a portion of the electrode assembly 20 that extends from its second (left) end portion toward a second side. The negative electrode tab 24t is a portion where the negative electrode active material layer 24b is not formed and the negative electrode current collector foil 24a is exposed. The negative electrode tab 24t is formed by laminating a plurality of layers of the negative electrode current collector foils 24a protruding toward the second side. The length from the tip of the positive electrode tab 23t to the tip of the negative electrode tab 24t is longer than the length of the case body 12 in the long side direction X. The electrode assembly 20 is housed in the battery case 10 while being covered with the insulating film 50. In the present embodiment, the positive electrode current collector foil 23a and the negative electrode current collector foil 24a have the positive electrode tab 23t and the negative electrode tab 24t, respectively, but are not limited thereto. In other embodiments, the positive electrode current collector foil 23a and the negative electrode current collector foil 24a may not have the positive electrode tab 23t and the negative electrode tab 24t, respectively. In such cases, both ends of the positive electrode current collector foil 23a and the negative electrode current collector foil 24a only need to be pulled in a separation step S4 described later.

The positive electrode 21 typically has the positive electrode current collector foil 23a and the positive electrode active material layer 23b adhered onto at least one surface of the positive electrode current collector foil 23a. The positive electrode current collector foil 23a here has a substantially rectangular shape. The positive electrode current collector foil 23a is made of conductive metal, such as aluminum, an aluminum alloy, nickel, or stainless steel, for example. The positive electrode current collector foil 23a here is a metal foil, specifically an aluminum foil.

The positive electrode active material layer 23b is provided on the positive electrode current collector foil 23a. The positive electrode active material layer 23b contains a positive electrode active material that can reversibly absorb and release charge carriers. As the positive electrode active material, oxides containing at least one of Ni, Co, and Mn are preferable. Examples thereof include lithium transition metal composite oxides such as lithium cobalt oxide, lithium manganese oxide, lithium nickel oxide, lithium nickel manganese composite oxide, and lithium nickel cobalt composite oxide. The positive electrode active material preferably contains, for example, a lithium nickel composite oxide containing Ni and Li, wherein a Ni content in the composite oxide is in the range of 70 to 100 mol % relative to the total number of moles of constituent elements in the composite oxide, excluding Li and oxygen. The positive electrode active material may also include materials in which a part of Ni, Co, and Mn is substituted with Al, Ti, Zr, P, B, Si, Nb, C, or the like, or materials in which some particle surfaces are covered with a compound containing Al, Ti, Zr, W, P, B, Si, Nb, C, or the like. The total amount of substitution and addition is about 0.1 to 7 mol %.

The negative electrode 22 typically has the negative electrode current collector foil 24a and the negative electrode active material layer 24b adhered onto at least one surface of the negative electrode current collector foil 24a. The negative electrode current collector foil 24a here has a substantially rectangular shape. The negative electrode current collector foil 24a is made of conductive metal, such as copper, a copper alloy, nickel, or stainless steel, for example. The negative electrode current collector foil 24a here is a metal foil, specifically a copper foil.

The negative electrode active material layer 24b is provided on the negative electrode current collector foil 24a. The negative electrode active material layer 24b contains a negative electrode active material that can reversibly absorb and release charge carriers. Examples of negative electrode active materials include carbon materials such as graphite and carbon, and metals and their compounds that can absorb lithium, such as Si, SiO, SiC, and Sn.

The separator 26 is a member that insulates the positive electrode active material layer 23b and the negative electrode active material layer 24b from each other. A porous resin sheet made of polyolefin resin such as polyethylene (PE) or polypropylene (PP), for example, is suitable for the separator 26. A heat resistance layer (HRL) containing an inorganic filler may be provided on the surface of the separator 26. As the inorganic filler, for example, alumina, boehmite, aluminum hydroxide, titania, or the like can be used.

The electrolyte solution is housed inside the battery case 10 together with the electrode assembly 20. The electrolyte solution may be the same as that in a typical secondary battery, and is not particularly limited. The electrolyte solution is typically a non-aqueous liquid electrolyte (non-aqueous electrolyte solution) that contains a non-aqueous solvent and a supporting salt. Examples of non-aqueous solvents include carbonates such as ethylene carbonate (EC), ethyl methyl carbonate (EMC), and dimethyl carbonate (DMC).

The non-aqueous solvent is preferably a mixture of EC, EMC, and DMC, with the content of each solvent being in the range of 1 to 99% by volume, such that the total content of the mixture is 100% by volume. The supporting salt is, for example, a fluorine-containing lithium salt. Preferred examples of the fluorine-containing lithium salt includes lithium hexafluorophosphate (LiPF₆), lithium bis(fluorosulfonyl)imide (F₂LiNO₄S₂), called LiFSI, or a mixture thereof. The concentration of the supporting salt is preferably 0.6 to 1.8 mol per liter of the non-aqueous solvent.

The insulating film 50 is housed inside the battery case 10 together with the electrode assembly 20. The insulating film 50 is disposed between the battery case 10 and the electrode assembly 20. The insulating film 50 covers the perimeter of the electrode assembly 20, as illustrated in FIG. 4. More specifically, the insulating film 50 preferably covers at least curved portions of the electrode assembly 20 that are opposed to the bottom surface 12a thereof, and a pair of flat surfaces of the electrode assembly 20. The insulating film 50 is composed of a single sheet-shaped material that is assembled into a box, bag or tube shape, for example.

The above description is given on the battery 100 (lithium-ion secondary battery) as an example of an object to be recovered. In a process of recycling used batteries, it is strongly desired to recover metals such as lithium (Li), nickel (Ni), cobalt (Co), and manganese (Mn) (so-called “rare metals”) contained in the electrode materials. There is also a need to recover aluminum (Al), copper (Cu), and other metals contained in the electrode current collector foil. When recycling batteries, if the battery 100 is crushed as-is, the metals to be recovered are mixed with metals other than those to be recovered, resulting in a relatively low recovery rate of the metals to be recovered. On the other hand, in cases where the battery 100 is not crushed, it is preferable to remove the electrode assembly 20 from the battery 100, separate the positive electrode current collector foil 23a, the negative electrode current collector foil 24a, and the separator 26 from one another, and recover the metals to be recovered from the positive electrode 21 and the negative electrode 22. However, according to the inventor's studies, it has been found that particularly in the electrode assembly 20 (laminated electrode assembly) as described above, the adhesion among the positive electrode current collector foil 23a, the negative electrode current collector foil 24a, and the separator 26 is strong, which makes it difficult to separate them. It has also been found that in the laminated electrode assembly, unlike a wound electrode assembly, it is difficult to peel apart the positive electrode current collector foil 23a, the negative electrode current collector foil 24a, and the separator 26. Therefore, the inventors have investigated a method that can efficiently recover the resources contained in the positive electrode 21 and the negative electrode 22 from the electrode assembly 20 (laminated electrode assembly).

### <Battery Disassembly Device>

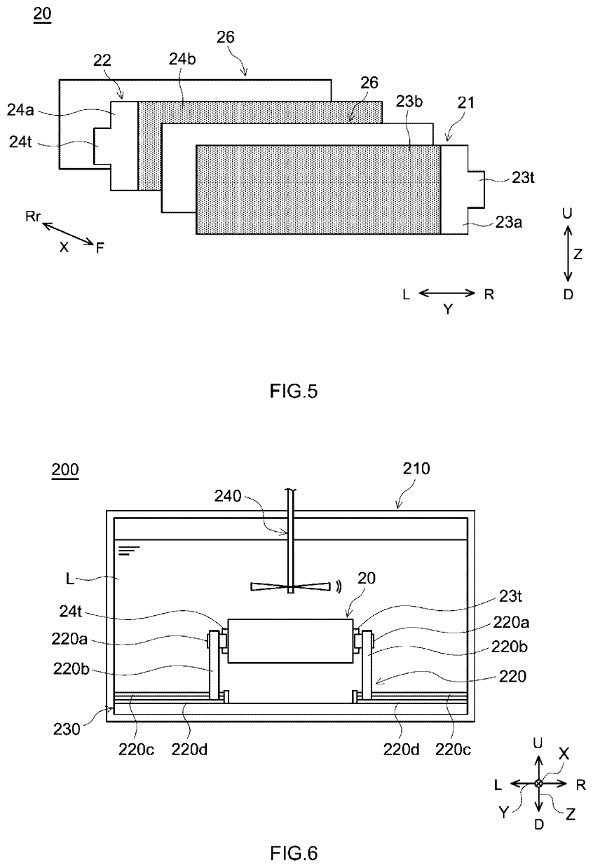

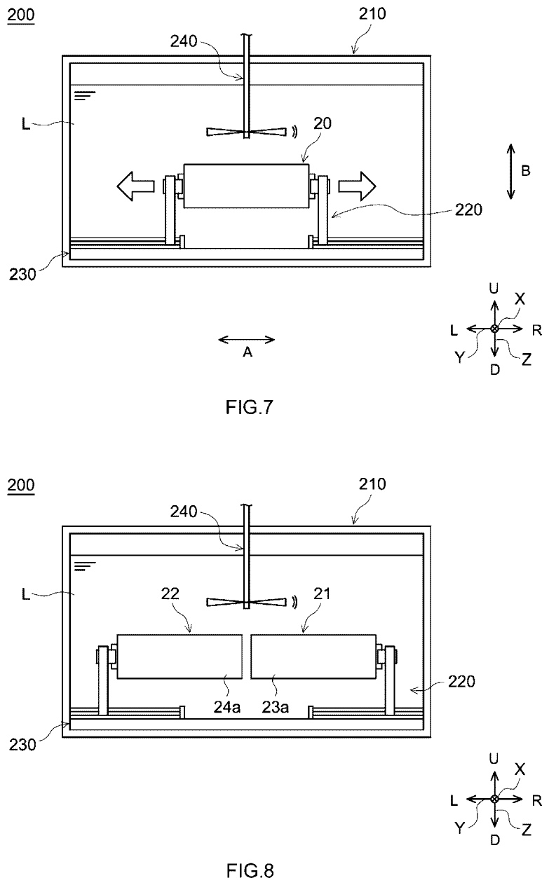

The disassembly method for a battery according to the present embodiment will then be described by using a battery disassembly device 200 that embodies the disassembly method for the battery 100. First, the battery disassembly device 200 according to the present embodiment will be described. Here, FIG. 6 is a schematic diagram illustrating the battery disassembly device according to one embodiment. FIG. 7 is a schematic explanatory diagram for explaining a separation step in the disassembly method for a battery according to the embodiment. As illustrated in FIG. 6, the battery disassembly device 200 according to the present embodiment includes a container 210, a pulling member 220, an oscillating member 230, and a stirring member 240. Each component is described below.

### <Container 210>

The container 210 is a container having a substantially rectangular parallelepiped shape with an opening (not shown) in part of its top surface. The container 210 contains liquid L (solution) therein. Here, the shape of the container 210 is not particularly limited as long as the effects of the technology disclosed herein are exhibited. The shape of the container 210 may have a substantially rectangular parallelepiped shape, as in the present embodiment, or in other embodiments, it may have various shapes, such as a cylindrical shape or a polygonal cylinder shape, for example. The material constituting the container 210 is not particularly limited as long as the effects of the technology disclosed herein are exhibited. Examples of materials constituting the container 210 include glass and acrylic resin. As the container 210, for example, a commercially available container can be used. In addition, the position of an upper end of the liquid L is not particularly limited as long as the effects of the technology disclosed herein are exhibited. From the viewpoint of easily separating the positive electrode current collector foil 23a and the negative electrode current collector foil 24a, it is preferable that the position of the upper end of the liquid L reaches a level near the upper end of the container 210, as in the present embodiment. Although not illustrated, the container 210 may be provided with a supply channel for supplying the liquid L inside the container 210, a discharge channel for discharging the liquid L inside the container 210, or the like.

### <Pulling Member 220>

The pulling member 220 is a member that pulls at least one of the positive electrode current collector foil 23a and the negative electrode current collector foil 24a, which are immersed in the liquid, so as to displace the positive electrode current collector foil 23a and the negative electrode current collector foil 24a in a direction (Y direction in FIG. 6) that intersects their laminating direction (X direction in FIG. 6). The pulling member 220 separates the positive electrode current collector foil 23a and the negative electrode current collector foil 24a from each other. As illustrated in FIG. 6, the pulling member 220 has gripping portions 220a, supporting portions 220b, screw shafts 220c, and guide rails 220d.

The gripping portions 220a are provided in a pair along the width direction Y of the electrode assembly 20, as illustrated in FIG. 6. Although not illustrated, the gripping portions 220a can pinch an object with an urging force of a spring or the like. The pair of gripping portions 220a is configured to grip the positive electrode current collector foil 23a (here, the positive electrode tab 23t) and the negative electrode current collector foil 24a (here, the negative electrode tab 24t), respectively. When the pair of gripping portions 220a grips the positive electrode tab 23t and the negative electrode tab 24t, the electrode assembly 20 is disposed in the liquid L. The supporting portions 220b are provided in a pair along the width direction Y of the electrode assembly 20, as illustrated in FIG. 6. The supporting portions 220b are members that support the electrode assembly 20. The screw shafts 220c are configured to assist the movement of the supporting portions 220b. The supporting portion 220b can move along the width direction Y via the screw shaft 220c. The guide rails 220d are configured to assist the movement of the supporting portions 220b. The supporting portion 220b can move along the width direction Y via the guide rail 220d. The gripping portion 220a, the supporting portions 220b, and the guide rail 220d can be made of resin, such as acrylic resin, for example. The screw shaft 220c can be made of metal, for example. As illustrated in FIG. 6, in the present embodiment, the vertical direction Z of the electrode assembly 20 in the liquid L coincides with the vertical direction in the drawing view. However, the direction of arrangement of the electrode assembly 20 is not particularly limited as long as the effects of the technology disclosed herein are exhibited. For example, the electrode assembly 20 may be arranged such that the laminating direction X coincides with the vertical direction in the drawing view of FIG. 6.

The pulling member 220 here is controlled by a control unit (not illustrated). Such a control unit includes an arithmetic unit (CPU), a storage unit (memory), an input unit, an output unit, and the like, as in a general control unit. The storage unit stores a program that is configured to cause the pulling member 220 to pull at least one of the positive electrode current collector foil 23a and the negative electrode current collector foil 24a, which are immersed in the liquid, so as to displace it in the direction intersecting their laminating direction. The arithmetic unit reads and executes this program, causing the pulling member 220 to perform the pulling. Since the configuration of the control unit itself does not characterize the technology disclosed herein, a detailed description thereof is omitted.

### <Oscillating Member 230>

The oscillating member 230 is a member that oscillates (shakes) the electrode assembly 20 in the liquid L. In the present embodiment, the oscillating member 230 is configured to be able to shake the electrode assembly 20 in the direction (Y direction in FIG. 6) that intersects the laminating direction (X direction in FIG. 6) of the positive electrode current collector foil 23a and the negative electrode current collector foil 24a (see the black arrow A in FIG. 7). In the present embodiment, the oscillating member 230 is further configured to be able to shake the electrode assembly 20 in a direction (Z direction in FIG. 6) that intersects the laminating direction (X direction in FIG. 6) of the positive electrode current collector foil 23a and the negative electrode current collector foil 24a and also intersects the displacement direction (Y direction in FIG. 6) of the positive electrode current collector foil 23a and the negative electrode current collector foil 24a (see the black arrow B in FIG. 7). As the oscillating member 230, for example, a commercially available reciprocating shaker or oscillator can be used. As illustrated in FIG. 6, in the present embodiment, the oscillating member 230 is disposed in the liquid L. However, in other embodiments, the oscillating member 230 may be disposed under the container 210 or the like.

The oscillating member 230 here is controlled by a control unit (not illustrated). Such a control unit includes an arithmetic unit (CPU), a storage unit (memory), an input unit, an output unit, and the like, as in a general control unit. The storage unit stores a program configured to cause the oscillating member 230 to shake the electrode assembly 20 in a predetermined direction. The arithmetic unit then reads and executes this program, causing the oscillating member 230 to perform the oscillating. Since the configuration of the control unit itself does not characterize the technology disclosed herein, a detailed description thereof is omitted.

### <Stirring Member 240>

The stirring member 240 is a member that stirs the liquid L in the container 210. As illustrated in FIG. 6, in the present embodiment, the stirring member 240 has a stirring blade. Such a stirring blade can efficiently stir the liquid L. As the stirring member 240, for example, a commercially available stirring device can be used. Alternatively, in other embodiments, a stirrer or the like may be used instead of the stirring member 240.

The stirring member 240 here is controlled by a control unit (not illustrated). Such a control unit includes an arithmetic unit (CPU), a storage unit (memory), an input unit, an output unit, and the like, as in a general control unit. The storage unit stores a program configured to cause the stirring member 240 to stir the liquid L. The arithmetic unit then reads and executes this program, causing the stirring member 240 to perform the stirring. Since the configuration of the control unit itself does not characterize the technology disclosed herein, a detailed description thereof is omitted.

### <Disassembly Method for Battery>

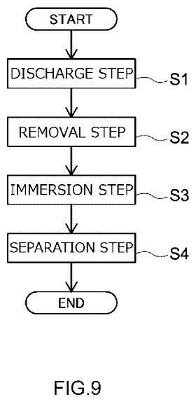

Next, the disassembly method for the battery according to the present embodiment will be described with reference to the battery disassembly device 200. Here, FIG. 8 is a schematic explanatory diagram for explaining the separation between the positive electrode current collector foil and the negative electrode current collector foil. FIG. 9 is a flowchart for explaining a disassembly method for a battery according to another embodiment. As illustrated in FIG. 9, the disassembly method for the battery according to the present embodiment includes a removal step S2 of removing the electrode assembly 20 from the battery 100, which includes the electrode assembly 20 in which the positive electrode current collector foils 23a and the negative electrode current collector foils 24a are laminated with the separator 26 interposed between adjacent electrode current collector foils. The method also includes an immersion step S3 of immersing at least a part (here, all) of the removed electrode assembly 20 in the liquid. The method further includes the separation step S4 of separating the positive electrode current collector foil 23a and the negative electrode current collector foil 24a from each other by pulling at least one (here, both) of the positive electrode current collector foil 23a and the negative electrode current collector foil 24a immersed in the liquid so as to displace the positive electrode current collector foil 23a and the negative electrode current collector foil 24a in the direction intersecting their laminating direction.

As described above, in such a disassembly method for a battery, the electrode assembly 20 is immersed in the liquid L in the immersion step S3. At this time, the liquid L infiltrates among the laminated positive electrode current collector foil 23a, negative electrode current collector foil 24a, and separator 26. This can weaken the surface tension acting among the positive electrode current collector foil 23a, the negative electrode current collector foil 24a, and the separator 26. Then, in the separation step S4, the positive electrode current collector foil 23a and the negative electrode current collector foil 24a can be pulled and displaced from each other. As a result, the positive electrode current collector foil 23a and the negative electrode current collector foil 24a can be easily separated from each other. Therefore, according to such a disassembly method for a battery, the resources contained in the positive electrode 21 and the negative electrode 22 can be efficiently recovered from the electrode assembly 20 (laminated electrode assembly).

In addition to the removal step S2, the immersion step S3, and the separation step S4 as described above, the disassembly method for the battery according to the present embodiment further includes a discharge step S1. Each step will be described below. In the following description, “SOC” means State of Charge. Specifically, in the present disclosure, SOC=100% is defined as the state of charge in which the operating voltage reaches its upper limit (i.e., the voltage does not increase even if charging is continued). On the other hand, SOC=0% is defined as the state of charge in which the operating voltage reaches its lower limit (i.e., the voltage does not decrease even if discharging is continued). As for the specific means of measuring SOC, any conventionally known measurement means can be adopted without particular limitations. Since the specific means of measurement does not limit the technology disclosed herein, a detailed description thereof is omitted.

### <Discharge Step S1>

In the discharge step S1, the electrode assembly 20 is discharged until its voltage becomes equal to or lower than the voltage at which the SOC reaches 0%. By discharging the electrode assembly 20 until its voltage becomes equal to or lower than the voltage at which the SOC reaches 0%, the negative electrode current collector foil 24a is reduced. Thus, the negative electrode active material layer 24b formed on the negative electrode current collector foil 24a becomes more likely to be peeled off. That is, it becomes easier to separate the electrode assembly 20 into the negative electrode current collector foil 24a and the rest. By making it easier to separate the negative electrode current collector foil 24a from the electrode assembly 20 in this way, the refining recovery rate is suitably improved. Although not particularly limited, the voltage that is “equal to or lower than the voltage at which the SOC reaches 0%” is preferably 4 V or lower, or 3 V or lower, and more preferably 2 V or lower, or 1 V or lower, from the viewpoint of facilitating the peeling of the negative electrode active material layer 24b by reducing the surface of the negative electrode current collector foil 24a (particularly, in the case of a copper foil). One example of a method of discharging the electrode assembly 20 until the voltage becomes equal to or lower than the voltage at which the SOC reaches 0% is a method involving inserting a resistor in series between a light bulb as a load and the battery 100. Alternatively, a method of discharging the battery using a discharger is also exemplified as an example. Such discharge is preferably a constant current constant voltage (CCCV) discharge.

In a more preferred embodiment, in the discharge step S1, the discharge is continued with the voltage of the electrode assembly 20 being equal to or lower than the voltage at which the SOC reaches 0%. Even when the voltage is equal to or lower than the voltage at which the SOC reaches 0%, the reduction of the negative electrode current collector foil 24a is further advanced by continuing to discharge the electrode assembly 20. This facilitates separating the electrode assembly 20 into the negative electrode current collector foil 24a and the rest. By making it easier to separate the negative electrode current collector foil 24a from the electrode assembly 20 in this way, the refining recovery rate is suitably improved. The suitable value of the voltage “that is equal to or lower than the voltage at which the SOC reaches 0%” is as described above. The time during which the discharge is continued (hereinafter also referred to as a “discharge time”) in a state of such a voltage or lower is not particularly limited as long as the effects of the technology disclosed herein are exhibited. Such a discharge time is, for example, 20 hours or more, and is preferably 24 hours or more, 30 hours or more, and more preferably 40 hours or more, 50 hours or more, or 60 hours or more from the viewpoint of further progressing the reduction of the negative electrode current collector foil 24a. The upper limit of the discharge time is not particularly limited, but is, for example, 80 hours or less, or may be 70 hours or less. For example, such a discharge time can be suitably reduced by performing the discharge at a lower voltage in the discharge step S1. An example of a method of discharging the battery with the voltage of the electrode assembly 20 being equal to or lower than the voltage at which the SOC reaches 0% has been described hereinabove. Such a discharge time can be suitably shortened by discharging the battery 100 while heating. In this case, the heating temperature of the battery 100 can be in the range of 40° C. to 80° C. (preferably 50° C. to 70° C.), for example.

### <Removal Step S2>

As described above, in the removal step S2, the electrode assembly 20 is removed from the battery 100 including the electrode assembly 20, in which the positive electrode current collector foil 23a and the negative electrode current collector foil 24a are laminated with the separator 26 interposed therebetween. In the present embodiment, the electrode assembly 20 is removed from the battery 100 by cutting both ends of the battery case 10 (both ends thereof in the Y direction of FIG. 1). Such cutting can be performed, for example, with a tool equipped with a cutting blade (e.g., an electric saw), a laser cutter, or the like. Commercially available tools can be used for this purpose.

### <Immersion Step S3>

As described above, in the immersion step S3, at least a part of the removed electrode assembly 20 is immersed in the liquid L. As illustrated in FIG. 6, in the present embodiment, the whole removed electrode assembly 20 is immersed in the liquid L inside the container 210. By immersing the electrode assembly 20 in the liquid L, the liquid L infiltrates among the laminated positive electrode current collector foil 23a, negative electrode current collector foil 24a, and separator 26. This can weaken the surface tension acting between the separator 26 and each of the positive electrode current collector foil 23a and the negative electrode current collector foil 24a.

The type of liquid L is not particularly limited as long as the effects of the technology disclosed herein are exhibited. Examples of the liquid L include water, acetone, ethanol, oil, and the like. These may be used alone or in combination of two or more. For example, commercially available products may be used as the liquid.

### <Separation Step S4>

As described above, in the separation step S4, at least one of the positive electrode current collector foil 23a and the negative electrode current collector foil 24a, which are immersed in the liquid, is pulled so as to displace the positive electrode current collector foil 23a and the negative electrode current collector foil 24a in the direction (here, the direction that is substantially orthogonal to the laminating direction, Y direction in FIG. 6) that intersects their laminating direction (X direction in FIG. 6). Then, as illustrated in FIG. 8, the positive electrode current collector foil 23a and the negative electrode current collector foil 24a are separated from each other. As illustrated in FIG. 6, in the present embodiment, the pulling member 220 pulls both the positive electrode current collector foil 23a and the negative electrode current collector foil 24a, which are immersed in the liquid, to separate the positive electrode current collector foil 23a and the negative electrode current collector foil 24a. More specifically, first, the positive electrode current collector foil 23a (here, the positive electrode tab 23t) and the negative electrode current collector foil 24a (here, the negative electrode tab 24t) are each gripped by the pair of gripping portions 220a. The supporting portion 220b is then moved in the direction of the white arrow in FIG. 7 via the screw shaft 220c and the guide rail 220d. In this way, the positive electrode current collector foil 23a and the negative electrode current collector foil 24a are separated from each other in the liquid L (see FIG. 8). As mentioned above, in the immersion step S3, the surface tension acting among the positive electrode current collector foil 23a, the negative electrode current collector foil 24a, and the separator 26 can be weakened. Then, in this step, the positive electrode current collector foil 23a and the negative electrode current collector foil 24a in that state are pulled and displaced from each other. This enables the separation between the positive electrode current collector foil 23a and the negative electrode current collector foil 24a while preventing foil breakage.

The force to pull the positive electrode current collector foil 23a (here, the positive electrode tab 23t) and the negative electrode current collector foil 24a (here, the negative electrode tab 24t) here is not particularly limited as long as the effects of the technology disclosed herein are exhibited. Such a pulling force is, for example, 1 N or more, preferably 2 N or more, more preferably 3 N or more, or 4 N or more, from the viewpoint of more easily separating the positive electrode current collector foil 23a and the negative electrode current collector foil 24a from each other. The upper limit of such a pulling force is, for example, 10 N or less, and from the viewpoint of suitably preventing foil breakage of the positive electrode current collector foil 23a and the negative electrode current collector foil 24a, it is preferably 9 N or less, and more preferably 8 N or less, 7 N or less, 6 N or less, and 5 N or less. The time during which the positive electrode current collector foil 23a and the negative electrode current collector foil 24a are pulled is not particularly limited as long as the effects of the technology disclosed herein are exhibited. Such a pulling time is, for example, in the range of 1 minute to 20 minutes, and from the viewpoint of suitably preventing foil breakage, it is preferably in the range of 2 minutes to 10 minutes.

In another preferred embodiment, the electrode assembly 20 is shaken in the liquid L before the separation step S4. More specifically, the electrode assembly 20 is shaken in the liquid L by the oscillating member 230. By shaking the electrode assembly 20 in the liquid L, the liquid L can easily infiltrate among the laminated positive electrode current collector foil 23a, negative electrode current collector foil 24a, and separator 26. Thus, in the separation step S4, the positive electrode current collector foil 23a and the negative electrode current collector foil 24a can be more easily separated from each other.

The speed at which the electrode assembly 20 is shaken in the liquid L (hereinafter also referred to as “oscillating speed”) is not particularly limited as long as the effects of the technology disclosed herein are exhibited. Such an oscillating speed is, for example, 20 times/min or more, and from the viewpoint of more suitably obtaining the effects described above, it is preferably 30 times/min or more, and more preferably 40 times/min or more. The upper limit of the oscillating speed is, for example, 60 times/min or less, and may be 50 times/min or less. The width of shaking the electrode assembly 20 in the liquid L (hereinafter also referred to as an “oscillating width”) is not particularly limited as long as the effects of the technology disclosed herein are exhibited. Such an oscillating width is, for example, 1 cm or more, and from the viewpoint of more suitably obtaining the effects described above, it is preferably 2 cm or more, and more preferably 3 cm or more. The upper limit of the oscillating speed is, for example, 5 cm or less, and may be 4 cm or less. The time during which the electrode assembly 20 is oscillated in the liquid L (hereinafter also referred to as an “oscillating time”) is not particularly limited as long as the effects of the technology disclosed herein are exhibited. The oscillating time is, for example, in the range of 1 minute to 15 minutes, and from the viewpoint of suitably preventing foil breakage, it is preferably in the range of 2 minutes to 10 minutes.

In another preferred embodiment, in the separation step S4, at least one of the positive electrode current collector foil 23a and the negative electrode current collector foil 24a is pulled while shaking the electrode assembly 20 in the liquid L. As illustrated in FIG. 7, in the present embodiment, both the positive electrode current collector foil 23a and the negative electrode current collector foil 24a are pulled while shaking the electrode assembly 20 in the liquid L. More specifically, the positive electrode current collector foil 23a (here, the positive electrode tab 23t) and the negative electrode current collector foil 24a (here, the negative electrode tab 24t) are pulled by the pulling member 220 while shaking the electrode assembly 20 in the liquid L using the oscillating member 230. By shaking the electrode assembly 20 in the liquid L, the liquid L can easily infiltrate among the laminated positive electrode current collector foil 23a, negative electrode current collector foil 24a, and separator 26. Thus, the positive electrode current collector foil 23a and the negative electrode current collector foil 24a can be more easily separated from each other. The oscillating speed, the oscillating width, and the oscillating time can be referred to the explanation above.

In another more preferred embodiment, in the separation step S4, the electrode assembly 20 is shaken in the direction (Y direction in FIG. 6) that intersects the laminating direction (X direction in FIG. 6) of the positive electrode current collector foil 23a and the negative electrode current collector foil 24a. More specifically, the positive electrode current collector foil 23a (here, the positive electrode tab 23t) and the negative electrode current collector foil 24a (here, the negative electrode tab 24t) are pulled by the pulling member 220 while shaking the electrode assembly 20 using the oscillating member 230 in the direction of the black arrow A in FIG. 7. At this time, the liquid L infiltrates into the laminated positive electrode current collector foil 23a, negative electrode current collector foil 24a, and separator 26 from their side surfaces. Thus, the liquid L can easily infiltrate among the positive electrode current collector foil 23a, the negative electrode current collector foil 24a, and the separator 26. Thus, the positive electrode current collector foil 23a and the negative electrode current collector foil 24a can be more easily separated from each other. The oscillating speed, oscillating width, and oscillating time can be referred to the explanation above.

In another preferred embodiment, in the separation step S4, the electrode assembly 20 is shaken in the direction (here, the direction substantially orthogonal to the displacement direction, Z direction in FIG. 6). This direction intersects the laminating direction (X direction in FIG. 6) of the positive electrode current collector foil 23a and the negative electrode current collector foil 24a and also intersects the displacement direction (Y direction in FIG. 6) of the positive electrode current collector foil 23a and the negative electrode current collector foil 24a. More specifically, the positive electrode current collector foil 23a (here, the positive electrode tab 23t) and the negative electrode current collector foil 24a (here, the negative electrode tab 24t) are pulled by the pulling member 220 while shaking the electrode assembly 20 using the oscillating member 230 in the direction of the black arrow B in FIG. 7. Both end portions of the positive electrode current collector foil 23a and the negative electrode current collector foil 24a in the displacement direction (Y direction in FIG. 6) are gripped by the respective gripping portions 220a. Meanwhile, no gripping portions 220a are present at both end portions thereof in the direction (Z direction in FIG. 6) intersecting the displacement direction (Y direction in FIG. 6). Thus, when shaking the electrode assembly 20 in the displacement direction, the liquid L can easily infiltrate among the laminated positive electrode current collector foil 23a, negative electrode current collector foil 24a, and separator 26. Thus, the positive electrode current collector foil 23a and the negative electrode current collector foil 24a can be more easily separated from each other. Note that the oscillating speed, the oscillating width, and the oscillating time can be referred to the explanation above.

In another preferred embodiment, in the separation step S4, at least one of the positive electrode current collector foil 23a and the negative electrode current collector foil 24a is pulled while stirring the liquid L. As illustrated in FIG. 6, in the present embodiment, both the positive electrode current collector foil 23a and the negative electrode current collector foil 24a are pulled while stirring the liquid L. More specifically, both the positive electrode current collector foil 23a (here, the positive electrode tab 23t) and the negative electrode current collector foil 24a (here, the negative electrode tab 24t), which are immersed in the liquid, are pulled by the pulling member 220 while stirring the liquid L using the stirring member 240. By stirring the liquid L, as in the shaking of the electrode assembly 20, the liquid infiltrates among the positive electrode current collector foil 23a, the negative electrode current collector foil 24a, and the separator 26. Thus, the positive electrode current collector foil 23a and the negative electrode current collector foil 24a can be more easily separated from each other.

The speed at which the liquid Lis stirred (hereinafter also referred to as a “stirring speed”) here is not particularly limited as long as the effects of the technology disclosed herein are exhibited. Such a stirring speed is, for example, 50 rpm or more, and from the viewpoint of more suitably obtaining the effects described above, it is preferably 100 rpm or more, and more preferably 200 rpm or more, or 300 rpm or more. The upper limit of the stirring speed is, for example, 500 rpm or less, and may be 400 rpm or less. The time during which the liquid Lis stirred (hereinafter also referred to as a “stirring time”) is not particularly limited as long as the effects of the technology disclosed herein are exhibited. Such a stirring time is, for example, in the range of 1 minute to 15 minutes, preferably in the range of 2 minutes to 10 minutes.

The positive electrode 21 and the negative electrode 22 that are separated from the electrode assembly 20 through the respective steps described above are refined using conventionally known methods. In the present embodiment, parts other than the copper foil are placed and refined in an alkaline solution (e.g., lithium hydroxide solution). Separating the copper in this way suitably leads to an improvement in the refining recovery rate. For example, since the battery 100 is a lithium-ion secondary battery in the present embodiment, valuable metals such as Li, Ni, Co, and Mn (so-called rare metals) derived from electrode active materials and metals such as Al and Cu derived from electrode current collector foils can be recovered. That is, according to the disassembly method for a battery disclosed herein, the resources contained in the positive electrode 21 and the negative electrode 22 can be efficiently recovered from the electrode assembly 20 (laminated electrode assembly).

The battery 100 can be used for various applications. For example, it can be suitably used as power sources (drive power sources) for motors installed in vehicles such as passenger cars and trucks. The type of vehicle is not particularly limited, but examples thereof include plug-in hybrid electric vehicles (PHEVs), hybrid electric vehicles (HEVs), battery electric vehicles (BEVs), and the like.

The embodiments of the technology disclosed herein have been described above. However, the above description is merely illustrative and is not intended to limit the scope of the claims. The technology described in the claims includes various modifications and changes of the specific examples illustrated in the above description.

For example, in the above embodiment, the entire electrode assembly 20 is immersed in the liquid L contained in the container 210. However, the electrode assembly 20 is not limited thereto. In other embodiments, only a part of the electrode assembly 20 may be immersed in the liquid.

For example, in the above embodiment, both the positive electrode current collector foil 23a (here, positive electrode tab 23t) and the negative electrode current collector foil 24a (here, negative electrode tab 24t), which are immersed in the liquid, are pulled by the pulling member 220, but they are not limited thereto. In other embodiments, only one of the positive electrode current collector foil 23a and negative electrode current collector foil 24a may be pulled.

For example, in the above embodiment, the positive electrode current collector foil 23a and the negative electrode current collector foil 24a are pulled while shaking the electrode assembly 20 in the liquid L, but the present disclosure is not limited thereto. In other embodiments, the electrode assembly 20 may not be shaken in the liquid L. In such cases, ultrasonic waves may be applied to the electrode assembly 20, thereby facilitating separation of the positive electrode current collector foil 23a and the negative electrode current collector foil 24a. For the application of such ultrasonic waves, a commercially available ultrasonic device can be used, for example.

For example, in the above embodiment, the positive electrode current collector foil 23a and the negative electrode current collector foil 24a are pulled while stirring the liquid L, but the present disclosure is not limited thereto. In other embodiments, the liquid L may not be stirred.

For example, the above embodiment includes, but is not limited to, the discharge step S1 of discharging the electrode assembly 20 until its voltage is equal to or lower than the voltage at which the SOC reaches 0%. Other embodiments may not include the discharge step S1.

For example, in the above embodiment, the direction intersecting the laminating direction of the positive electrode current collector foil 23a and the negative electrode current collector foil 24a is set substantially orthogonal to the laminating direction thereof. Further, the direction intersecting the displacement direction of the positive electrode current collector foil 23a and the negative electrode current collector foil 24a is set substantially orthogonal to the displacement direction thereof. However, the present disclosure is not limited thereto. That is, the intersecting direction is not limited to the orthogonal direction. In the former case, for example, the intersecting direction may be a direction that intersects at an angle other than a substantially right angle (about) 90° relative to the laminating direction. In the latter case, for example, the intersecting direction may be a direction that intersects at an angle other than a substantially right angle (about) 90° relative to the displacement direction.

The following is a description of test examples related to the technology disclosed herein. The contents of the test examples described below are not intended to limit the technology disclosed herein.

### Test Examples

First, test batteries, each including a laminated electrode assembly, were prepared. The test battery was then subjected to a constant current constant voltage (CCCV) discharge at 2 V for 30 hours. Subsequently, both ends of the battery case of the test battery were cut off, and the laminated electrode assembly was removed. In Test Example 1, a battery disassembly device such as that described above was prepared, and a positive electrode tab and a negative electrode tab of a laminated electrode assembly were each gripped by a pair of gripping portions. Then, the positive electrode tab and the negative electrode tab were pulled in water so as to displace a positive electrode current collector foil and a negative electrode current collector foil in the direction intersecting their laminating direction. In Test Example 2, after gripping a positive electrode tab and a negative electrode tab of the laminated electrode assembly by using the pair of gripping portions, the positive electrode tab and the negative electrode tab were pulled in air so as to displace a positive electrode current collector foil and a negative electrode current collector foil in the direction that intersects their laminating direction. Note that the positive electrode tab and the negative electrode tab were pulled while controlling a pulling force to 5 N or less. The pulling time was set to 3 minutes.

As a result, in Test Example 1, the positive electrode current collector foil and the negative electrode current collector foil were separated from each other. In contrast, in Test Example 2, the adhesion between the positive electrode current collector foil, the negative electrode current collector foil, and the separator was so strong that they were not separated from one another even when the pulling force was increased to 5N. Even when the pulling force was increased to 100 N, they were not able to be separated, resulting in foil breakage. From the above, it was confirmed that the positive electrode current collector foil and the negative electrode current collector foil cannot be separated in air, but can be successfully separated in liquid as described in the present disclosure.

As described above, the specific aspects of the technology disclosed herein include those described in the following items.

### Item 1

A disassembly method for an electricity storage device includes the steps of:
removing an electrode assembly from the electricity storage device, the electricity storage device including the electrode assembly in which a positive electrode current collector foil and a negative electrode current collector foil are laminated with a separator interposed therebetween;
immersing at least a part of the removed electrode assembly in a liquid; and
separating the positive electrode current collector foil and the negative electrode current collector foil by pulling at least one of the positive electrode current collector foil and the negative electrode current collector foil that are immersed in the liquid so as to displace the positive electrode current collector foil and the negative electrode current collector foil in a direction intersecting a laminating direction thereof.

### Item 2

The disassembly method for an electricity storage device according to Item 1, wherein the separation step includes pulling the at least one of the positive electrode current collector foil and the negative electrode current collector foil while shaking the electrode assembly in the liquid.

### Item 3

The disassembly method for an electricity storage device according to Item 2, wherein, in the separation step, the electrode assembly is shaken in a direction intersecting the laminating direction of the positive electrode current collector foil and the negative electrode current collector foil.

### Item 4

The disassembly method for an electricity storage device according to Item 3, wherein, in the separation step, the electrode assembly is shaken in a direction that intersects the laminating direction of the positive electrode current collector foil and the negative electrode current collector foil and also intersects the displacement direction of the positive electrode current collector foil and the negative electrode current collector foil.

### Item 5

The disassembly method for an electricity storage device according to any one of Items 1 to 4, wherein the separation step includes pulling the at least one of the positive electrode current collector foil and the negative electrode current collector foil while stirring the liquid.

### Item 6

The disassembly method for an electricity storage device according to any one of Items 1 to 5, further including the step of:
discharging the electrode assembly until a voltage thereof becomes equal to or lower than a voltage at which SOC reaches 0%.

### Item 7

The disassembly method for an electricity storage device according to Item 6, wherein in the discharge step, the discharging is continued in a state where a voltage of the electrode assembly becomes equal to or lower than the voltage at which the SOC reaches 0%.

What is claimed is:

1. A disassembly method for an electricity storage device, comprising the steps of:
removing an electrode assembly from the electricity storage device, the electricity storage device including the electrode assembly in which a positive electrode current collector foil and a negative electrode current collector foil are laminated with a separator interposed therebetween;
immersing at least a part of the removed electrode assembly in a liquid; and
separating the positive electrode current collector foil and the negative electrode current collector foil by pulling at least one of the positive electrode current collector foil and the negative electrode current collector foil that are immersed in the liquid so as to displace the positive electrode current collector foil and the negative electrode current collector foil in a direction intersecting a laminating direction thereof.

2. The disassembly method for an electricity storage device according to claim 1, wherein the separation step comprises pulling the at least one of the positive electrode current collector foil and the negative electrode current collector foil while shaking the electrode assembly in the liquid.

3. The disassembly method for an electricity storage device according to claim 2, wherein, in the separation step, the electrode assembly is shaken in a direction intersecting the laminating direction of the positive electrode current collector foil and the negative electrode current collector foil.

4. The disassembly method for an electricity storage device according to claim 3, wherein, in the separation step, the electrode assembly is shaken in a direction that intersects the laminating direction of the positive electrode current collector foil and the negative electrode current collector foil and also intersects the displacement direction of the positive electrode current collector foil and the negative electrode current collector foil.

5. The disassembly method for an electricity storage device according to claim 1, wherein the separation step comprises pulling the at least one of the positive electrode current collector foil and the negative electrode current collector foil while stirring the liquid.

6. The disassembly method for an electricity storage device according to claim 1, further comprising the step of:
discharging the electrode assembly until a voltage thereof becomes equal to or lower than a voltage at which SOC reaches 0%.

7. The disassembly method for an electricity storage device according to claim 6, wherein, in the discharge step, the discharging is continued in a state where a voltage of the electrode assembly becomes equal to or lower than the voltage at which the SOC reaches 0%.
